(19) United States
(12) Patent Application Publication
(10) Pub. No.: US 2017/0357282 A1
(43) Pub. Date: Dec. 14, 2017

(54) AUTONOMOUS POWER AND TIMING SYSTEM

(71) Applicant: Integrated Device Technology, Inc., San Jose, CA (US)

(72) Inventor: Richard Maria SCHMITZ, San Tan Valley, AZ (US)

(21) Appl. No.: 15/616,553

(22) Filed: Jun. 7, 2017

Related U.S. Application Data
(60) Provisional application No. 62/347,515, filed on Jun. 8, 2016.

(51) Int. Cl. G05F 3/02

(52) U.S. Cl. CPC G05F 3/02

(57) ABSTRACT

In accordance with aspects of the present invention, and power and timing supply is presented. The supply includes a power supply providing a supply voltage as a function of a load current; and a timing generator providing a frequency signal as a function of the supply voltage, wherein the supply voltage and the frequency signal are within a safe operating range.

### RELATED APPLICATIONS

The present disclosure claims priority to U.S. Provisional Patent Application 62/347,515, entitled “Autonomous Power and Timing System,” filed on Jun. 8, 2016, which is herein incorporated by reference in its entirety.

### BACKGROUND

### Technical Field

Embodiments of the present invention are related power supplies and, in particular, to an autonomous power and timing system to provide power to a load.

### Discussion of Related Art

Power management is an integral component of overall system design. Power management has become an important aspect of circuit design. In particular, providing power at reliable levels under conditions of widely varying loads and frequency requirements is a challenge.

Consequently, there is a need for better power supplies.

### SUMMARY

In accordance with aspects of the present invention, and power and timing supply is presented. The supply includes a power supply providing a supply voltage as a function of a load current; and a timing generator providing a frequency signal as a function of the supply voltage, wherein the supply voltage and the frequency signal are within a safe operating range.

These and other embodiments are further discussed below with respect to the following figures.

### BRIEF DESCRIPTION OF THE DRAWINGS

FIG. 1 illustrates a power and timing system according to aspects of the present invention.

FIG. 2 illustrates an example function between voltage and current for the power generator illustrated in FIG. 1.

FIG. 3 illustrates a relationship between frequency and voltage of the timing generator illustrated in FIG. 1.

FIG. 4 illustrates an example relationship between frequency and voltage of the timing generator illustrated in FIG. 1.

FIG. 5 illustrates an example relationship between frequency and voltage of the timing generator illustrated in FIG. 1.

### DETAILED DESCRIPTION

In the following description, specific details are set forth describing some embodiments of the present invention. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure.

This description and the accompanying drawings that illustrate inventive aspects and embodiments should not be taken as limiting—the claims define the protected invention. Various changes may be made without departing from the spirit and scope of this description and the claims. In some instances, well-known structures and techniques have not been shown or described in detail in order not to obscure the invention.

Elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

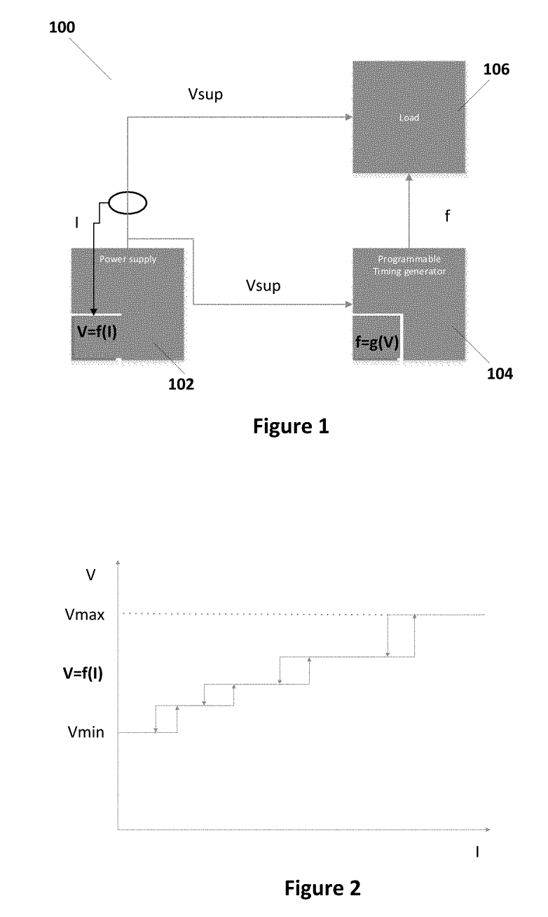

FIG. 1 illustrates a power system 100 according to some embodiments of the present invention. As illustrated in FIG. 1, power system 100 includes a power supply 102 that outputs a voltage Vsup to load 106. As illustrated in FIG. 1, the voltage output of power supply is given by V=f(I), where I is the current provided to load 106. The supply voltage is input to a load 106 and at least a derivative of the voltage Vsup is provided to a programmable timing generator 104. Generator 104 produces a frequency f that is, at least in part, a function of the voltage received into programmable timing generator 104, f=g(V). The frequency f is also input to load 106, which uses the frequency f to modulate the input voltage Vsup.

Consequently, power supply 102 is capable of measuring or receiving the load current I. Timing generator 104 receives the load supply voltage Vsup or a voltage proportional to the load supply voltage Vsup, which is dependent on the current drawn by the load 106.

Power supply 102 may include a microprocessor and memory to hold programming instructions and data to perform the calculation of the output voltage Vsup based on the load current I. In some embodiments, the calculation of the output voltage can be performed by dedicated circuitry within power supply 102.

The relationship between supply voltage Vsup and supply current I can be a linear or nonlinear relationship. In some embodiments, power supply 102 may include a lookup table or another function description that defines the function f(I), the current/voltage relation. The function f(I) may include hysteresis.

FIG. 2 illustrates an example current/voltage relationship f(I) that includes hysteresis. The voltage range for load 106 can be programmed to match the acceptable supply voltage range for load 106. As is illustrated in FIG. 2, the function f(I) can be a step function with hysteresis so that operation with increasing current is different from operation with decreasing current. Such a function can be calculated using a look-up table, for example.

As is further illustrated in FIG. 1, the output voltage Vsup from power supply 102 is fed directly as a supply voltage or as an independent input voltage to timing generator 104. The supply voltage can then be used to determine the output frequency of timing generator 104. The determination of frequency f as a function of voltage can also be based on a lookup table or based on a function for the load 102. As such, timing generator 104 may also include a processor and memory for holding programming and data that can calculate the function g(V). In some embodiments, timing generator 104 and power supply 102 may share a single microprocessor system that is shared. The single microprocessor can calculate both the voltage and the frequency.

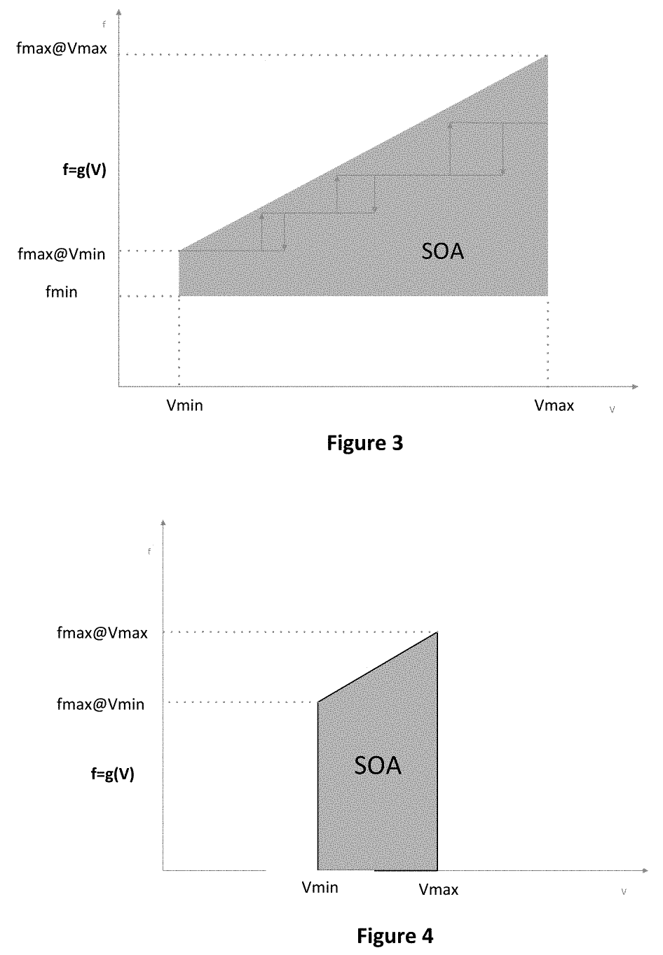

FIG. 3 illustrates the frequency as a function of voltage relationship that may be executed for timing generator 104. The frequency range can be programmed in timing generator 104 to match an acceptable frequency range for load 106.

As is further illustrated in FIG. 3, the supply voltage and the frequency can be programmed to stay within a safe operating area (SOA). As illustrated in FIG. 3, the output voltage ranges from a Vmin to a Vmax. The frequency range can be from a minimum frequency fmin to a maximum frequency fmax, where the maximum frequency fmax depends on the voltage. For example, there is a maximum frequency fmax at the minimum voltage Vmin and a different maximum frequency fmax at the maximum voltage Vmax. FIG. 4 shows a relationship where the frequency of load 106 can go to zero (0). In some systems, e.g. where DRAM is used, the frequency cannot go below a certain limit and therefore the minimum frequency (fmin@Vmin) is greater than 0.

As discussed above, FIG. 1 shows a block diagram of a proposed power/timing system 100. Power supply 102 generates a supply voltage Vsup to load 106. This Vsup, or a derivative of Vsup, is also input to timing generator 104. Vsup is modulated by the load current, which means that with a changing load current the output voltage Vsup is changed proportionally or in certain steps for a load current range as is illustrated in FIG. 2.

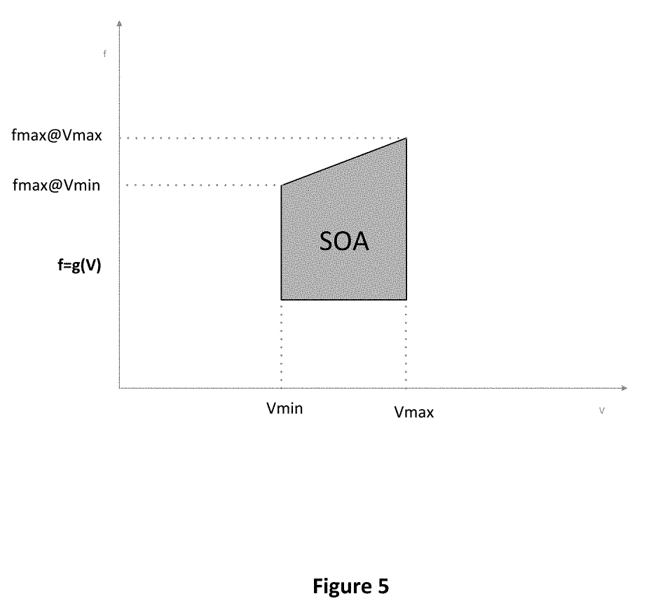

Vsup can either by the supply voltage of the timing generator or an independent input voltage. Vsup is then decoded in the timing generator to generate a Vsup specific frequency for a given Vsup or a range of Vsup, as is illustrated in FIG. 3. Vsup and the frequency are programmed to stay with the safe operating area SOA, as is illustrated in FIG. 3, FIG. 4, and FIG. 5. In certain cases, e.g. when there is an embedded DRAM included in the load, the frequency f is programmed not to go lower than a predefined value as is illustrated in FIG. 3 and FIG. 5. FIG. 4 illustrates an example where the minimum frequency can be 0.

The above detailed description is provided to illustrate specific embodiments of the present invention and is not intended to be limiting. Numerous variations and modifications within the scope of the present invention are possible. The present invention is set forth in the following claims.

What is claimed is:

1. A power and timing supply, comprising:
a power supply providing a supply voltage as a first function of a load current;
a timing generator providing a frequency signal as a second function of the supply voltage,
wherein the supply voltage and the frequency signal are within a safe operating range.

2. The supply of claim 1, wherein the first function includes hysteresis.

3. The supply of claim 1, wherein the power supply uses a look-up table to determine the supply voltage.

4. The supply of claim 1, wherein the second function determines a range of frequencies in the safe operating range.

5. The supply of claim 4, wherein the safe operating range includes a zero frequency.

6. The supply of claim 4, wherein the frequencies in the safe operating range are above a minimum frequency.

7. A method of providing power to a load, comprising:
determining a supply voltage from a load current to the load;
determining a frequency from the supply voltage; and
providing the supply voltage and the frequency to the load.

8. The method of claim 7, wherein determining the supply voltage includes calculating the supply voltage as a first function of the load current.

9. The method of claim 8, wherein the first function is performed with a look-up table.

10. The method of claim 8, wherein the first function includes hysteresis.

11. The method of claim 7, wherein determining the frequency includes calculating the frequency as a second function of the supply voltage.

12. The method of claim 11, wherein the second function is performed with a look-up table.
